(19) United States
(12) Patent Application Publication
(10) Pub. No.: US 2026/0079609 A1
(43) Pub. Date: Mar. 19, 2026

(54) IMAGE DATA STORAGE METHOD

(71) Applicant: SEIKO EPSON CORPORATION, Tokyo (JP)

(72) Inventor: Kensuke KIDA, MATSUMOTO-SHI (JP)

(21) Appl. No.: 19/331,633

(22) Filed: Sep. 17, 2025

(30) Foreign Application Priority Data
Sep. 18, 2024 (JP) 2024-160738

(51) Int. Cl. G06F 3/04817; G06F 3/0482; G06F 3/04883; G06F 16/51

(52) U.S. Cl. CPC G06F 3/04817; G06F 3/0482; G06F 3/04883; G06F 16/51

(57) ABSTRACT

An image data storage method includes receiving, at an information processing device that is communicably connected to a displayer that displays an image on a display surface, an operation of selecting first folder information; displaying, by the displayer, a first icon for storing an image displayed on the display surface; receiving, at the displayer, an operation of selecting the first icon being displayed; and storing, by the information processing device, image data of the image displayed on the display surface in a folder having a folder name based on second folder information and the first folder information.

The present application is based on, and claims priority from JP Application Serial Number 2024-160738, filed September 18, 2024, the disclosure of which is hereby incorporated by reference herein in its entirety.

### BACKGROUND

### 1. Technical Field

The present disclosure relates to an image data storage method.

### 2. Related Art

In the related art, a displayer that receives an operation on an image displayed on a display surface is known. For example, JP-A-2017-72795 discloses a Projection system that projects a screen keyboard image onto a projection surface and receives operations performed on the projected screen.

However, in the case of storing image data of an image displayed on a display surface, setting a storage destination by an image such as a screen keyboard image described in JP-A- 2017-72795 may complicate a user's operation.

### SUMMARY

An image data storage method includes receiving, at an information processing device that is communicably connected to a displayer that displays an image on a display surface, an operation of selecting first folder information; displaying, by the displayer, a first icon for storing an image displayed on the display surface; receiving, at the displayer, an operation of selecting the first icon being displayed; and storing, by the information processing device, image data of the image displayed on the display surface in a folder having a folder name based on second folder information and the first folder information.

### BRIEF DESCRIPTION OF THE DRAWINGS

FIG. 1 is a figure illustrating a system configuration of a System.

FIG. 2 is a side view illustrating an installation mode of the Projection system.

FIG. 3 is a block diagram illustrating a configuration of a Projection system.

FIG. 4 is a figure illustrating an example of a first icon.

FIG. 5 is a block diagram illustrating a configuration of an information processing device.

FIG. 6 is a figure illustrating an example of a folder name setting image.

FIG. 7A is a figure for explaining a list image.

FIG. 7B is a figure for explaining a list image.

FIG. 8 is a figure illustrating an example of an editing image.

FIG. 9A is a figure for explaining storage of capture image data.

FIG. 9B is a figure for explaining storage of capture image data.

FIG. 9C is a figure for explaining storage of capture image data.

FIG. 10 is a figure illustrating an example of a folder name setting image.

FIG. 11 is a flowchart illustrating an operation of the information processing device.

FIG. 12 is a flowchart illustrating the operation of the Projection system.

FIG. 13 is a flowchart illustrating the operation of the Projection system and the information processing device.

FIG. 14 is a flowchart illustrating the operation of the Projection system and the information processing device.

FIG. 15 is a flowchart illustrating the operation of the Projection system and the information processing device.

### DESCRIPTION OF EMBODIMENTS

### 1. First Embodiment

Hereinafter, a first embodiment will be described with reference to the accompanying drawings.

### 1-1. System configuration

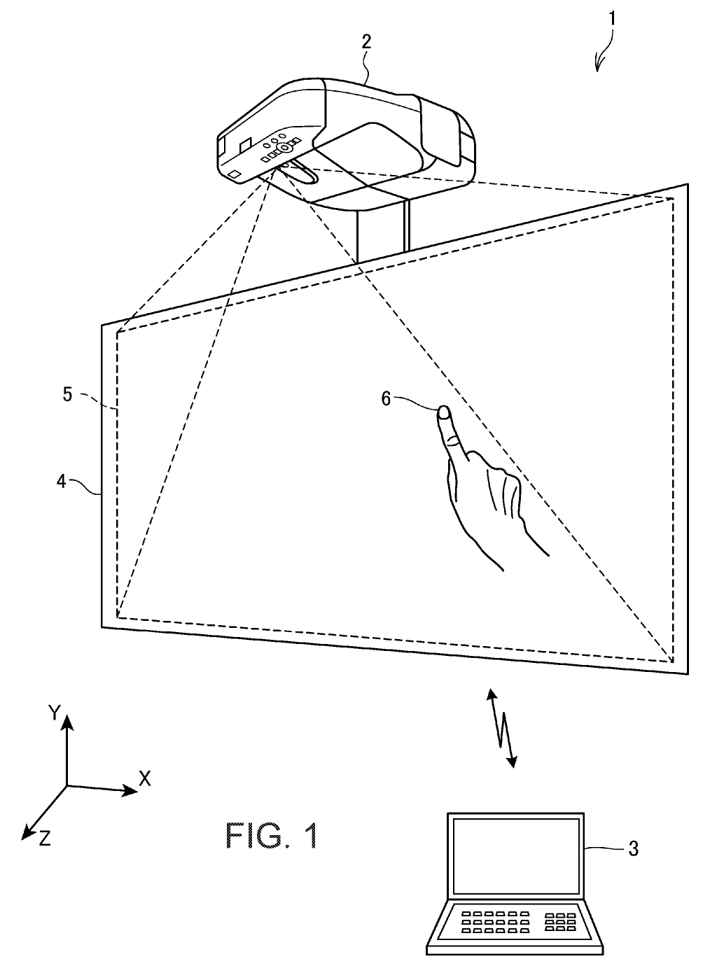

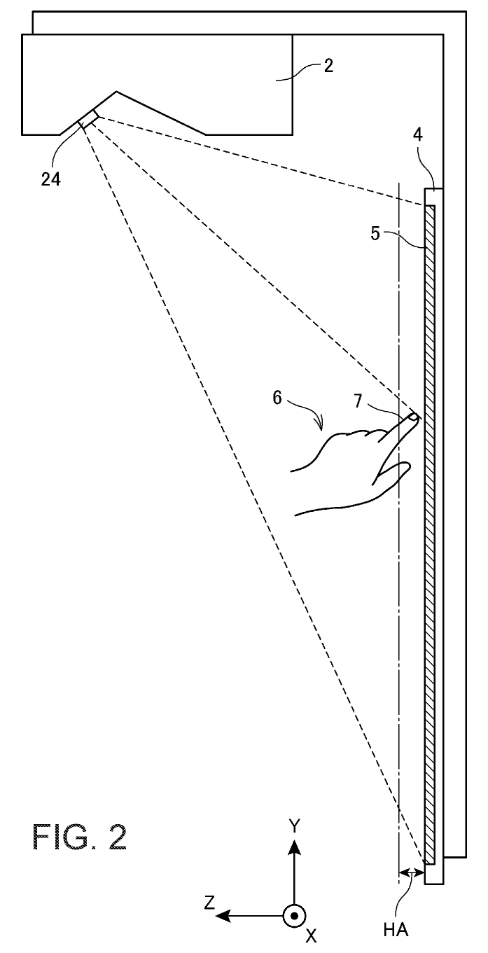

FIG. 1 is a figure illustrating a system configuration of a System 1. FIG. 2 is a side view illustrating an installation mode of a Projection system 2.

The System 1 is a system including a Projection system 2 and an information processing device 3. The Projection system 2 is an example of a "displayer”.

The Projection system 2 generates image light and emits the generated image light to the projection surface 4 to display an image on the projection surface 4.

Hereinafter, the normal line of the projection surface 4 is defined as the Z axis, the vertical axis is defined as the Y axis, and the axis perpendicular to the Z axis and the Y axis is defined as the X axis. The Z axis corresponds to the front-rear direction in the installation state of the Projection system 2. The positive direction of the Z-axis indicates the front. The Y axis corresponds to the vertical direction. The positive direction of the Y axis indicates upward. The X axis corresponds to the left-right direction. The positive direction of the X axis indicates the right direction.

The projection surface 4 is an example of a "display surface".

The Projection system 2 is installed in front of and above the projection surface 4 and emits image light toward the projection surface 4. Hereinafter, the region of the projection surface 4 from which the image light is emitted is referred to as a projection region 5. An image is displayed in the projection region 5 by the image light emitted from the Projection system 2.

It should be noted that the projection surface 4 may be a screen, a wall surface of a building, or a flat surface of an installation object. The projection surface 4 is not limited to a flat surface, and may be a curved surface or a surface having irregularities.

The Projection system 2 includes an interactive function. The interactive function is a function of detecting the position of the projection surface 4 designated by the indicator 6, displaying an image that corresponds to the position and the trajectory of the indicator 6 on the projection surface 4 based on the detected position, and executing processing that corresponds to the detected position.

In the present embodiment, a finger of a hand is illustrated as the indicator 6.

The Projection system 2 emits detection light LT in a direction corresponding to the projection surface 4. Therefore, when the tip end of the indicator 6 comes into contact with the projection surface 4, the indicator 6 blocks the detection light LT. The detection light LT hits the indicator 6 and is reflected, and a part of the reflected light of the detection light LT travels from the indicator 6 toward the Projection system 2. The Projection system 2 detects the reflected light obtained by the detection light LT being reflected by the indicator 6, and detects the position pointed by the indicator 6. The Projection system 2 emits the detection light LT in a direction corresponding to the projection surface 4. Specifically, the direction corresponding to the projection surface 4 is a direction in which the reflected light reflected by the indicator 6 in a range HA can be made incident on an infrared camera 25. The range HA is a range in the front-rear direction, and is a range in which the distance from the projection surface 4 to the front is equal to or smaller than a threshold. The detection light LT is emitted in a range including at least a part of the projection surface 4. In the present embodiment, the detection light LT is emitted in a range covering at least the entire projection region 5. It should be noted that the detection light LT is light used for detecting the indicator 6, and infrared light is used in the present embodiment.

The information processing device 3 supplies an image to the Projection system 2 that is communicably connected, stores image data of the image displayed on the projection surface 4, and the like. Hereinafter, the image data of the image displayed on the projection surface 4 is referred to as "captured image data". Although FIG. 1 illustrates a case where the information processing device 3 is a laptop personal computer (PC), the information processing device 3 may be a desktop type PC, a tablet terminal, a smartphone, or the like. Although FIG. 1 illustrates the case in which the information processing device 3 and the Projection system 2 are connected to each other wirelessly, the information processing device 3 and the Projection system 2 can also be connected to each other by wired connection.

### 1-2. Configurations of Projection system and information processing device

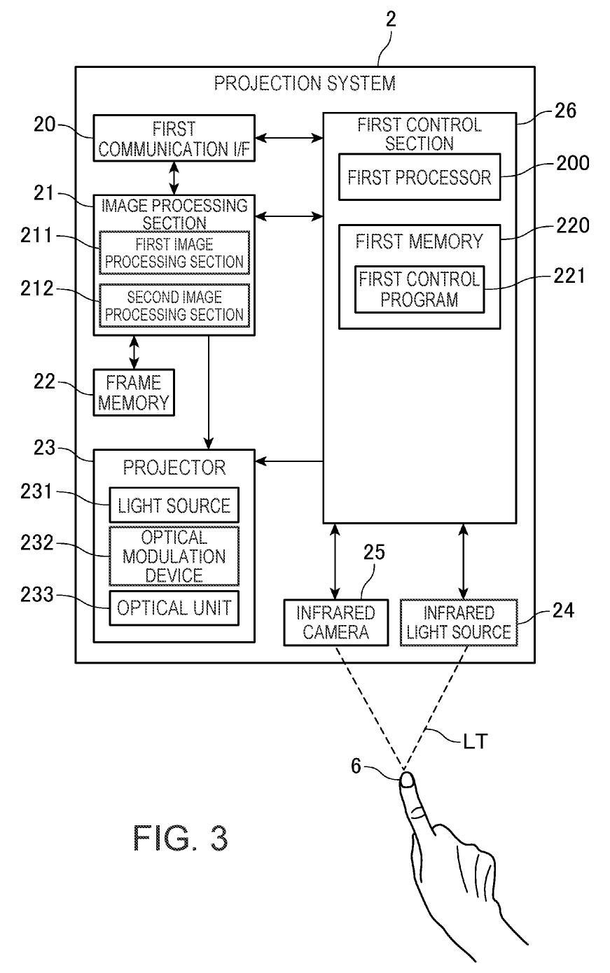

Next, the configuration of the Projection system 2 will be described with reference to FIG. 3.

FIG. 3 is a block diagram illustrating the configuration of the Projection system 2.

Infrared light source 24Infrared light source 24The Projection system 2 includes a first communication interface 20, an image processing section 21, a frame memory 22, a Projector 23, an infrared light source 24, the infrared camera 25, and a first control section 26. Hereinafter, the interface is abbreviated as I/F.

The first communication I/F 20 includes a connector, an interface circuit, and the like that conform to a predetermined communication standard. The first communication I/F 20 communicates with the information processing device 3 under the control of the first control section 26.

The image processing section 21 and the frame memory 22 are each formed of, for example, an integrated circuit. The integrated circuit includes a Large Scale Integration (LSI), an Application Specific Integrated Circuit (ASIC), a programmable logic device (PLD), a Field-Programmable Gate Array (FPGA), a System-on-a-chip (SoC), and the like. An analog circuit may be included in a part of the configuration of the integrated circuit, or the first control section 26 and the integrated circuit may be combined.

The frame memory 22 is connected to the image processing section 21. The frame memory 22 includes a plurality of banks. Each bank has a storage capacity capable of writing a display image of one frame. The frame memory 22 is configured by, for example, a Synchronous Dynamic RAM (SDRAM). The image processing section 21 develops an image input from the first communication I/F 20 in the frame memory 22.

The image processing section 21 includes a first image processing section 211 and a second image processing section 212.

The first image processing section 211 performs image processing on the image developed in the frame memory 22. The image processing performed by the first image processing section 211 includes, for example, a resolution conversion process or a resize process, distortion aberration correction, a shape correction process, a digital zoom process, adjustment of the tint or luminance of an image, and the like. The first image processing section 211 executes a process designated by the first control section 26, and performs the process using parameters input from the first control section 26 as necessary. The first image processing section 211 can of course execute a combination of a plurality of image processes among the above.

The second image processing section 212 performs drawing processing on the image data processed by the first image processing section 211. The second image processing section 212 performs drawing processing corresponding to the position of the indicator 6 on the projection surface 4 detected by the first control section 26. The position of the indicator 6 detected by the first control section 26 indicates the coordinates of the position of the reflected light in a captured image generated by the infrared camera 25 (to be described later) taking an image. The second image processing section 212 converts the coordinates into coordinates in the frame memory 22, and superimposes, at a position in the frame memory 22 indicated by the converted coordinates, the image data of a third image G3 that was drawn by the indicator 6.

The Projector 23 includes a light source 231, an optical modulation device 232, and an optical unit 233.

The light source 231 includes a discharge type light source lamp such as an ultra-high pressure mercury lamp or a metal halide lamp, or a solid state light source such as a light emitting diode or a semiconductor laser. The light emitted from the light source 231 is incident on the optical modulation device 232.

The optical modulation device 232 includes a transmission type liquid crystal panel in which liquid crystal is sealed between a pair of transparent substrates as a light modulation element that modulates the light emitted from the light source 231. The liquid crystal panel is not illustrated. The liquid crystal panel includes a panel region including a plurality of pixels arranged in a matrix. The optical modulation device 232 applies a drive voltage corresponding to an image input from the image processing section 21 to each pixel in the panel region to change the light transmittance of each pixel to a transmittance corresponding to the display image. The light emitted from the light source 231 is transmitted through the liquid crystal panel, whereby the light is modulated, and image light corresponding to an image to be projected is generated.

The light modulation element included in the optical modulation device 232 is not limited to the transmission type liquid crystal panel, and may be, for example, a reflection type liquid crystal panel or a DMD (Digital Micro Device).

The optical unit 233 includes a projection lens (not illustrated) and the like, and emits the image light modulated by the optical modulation device 232.

The infrared light source 24 emits the detection light LT for detecting the indicator 6 to a region including the projection surface 4. In FIG. 3, the detection light LT is indicated by broken line. The infrared light source 24 includes a Laser Diode (LD) or an LED as a light source that emits infrared light. The infrared light source 24 may include an optical component that diffuses the infrared light emitted by the light source toward the projection surface 4.

The infrared camera 25 includes an image pickup element such as a complementary metal oxide semiconductor (CMOS) or a charge coupled device (CCD) that receives the detection light LT emitted by the pointing indicator 6. The infrared camera 25 includes an optical system that forms an image on the image pickup element, an aperture that limits light incident on the image pickup element, and the like.

The infrared camera 25 captures an image of a range including the projection surface 4 to generate a captured image. The infrared camera 25 receives the detection light LT emitted by the indicator 6 and captures an image. The image data of the captured image generated by the infrared camera 25 is output to the first control section 26.

The first control section 26 is a computer device including a first processor 200 such as a Central Processing Unit (CPU) or a Micro Processing Unit (MPU), and a first memory 220.

The first memory 220 is a storage device that stores programs and data. The first memory 220 stores a first control program 221, data processed by the first processor 200, and the like. The first memory 220 has a non-volatile storage region. The first memory 220 includes a volatile storage region and constitutes a work area of the first processor 200. The first memory 220 is configured by, for example, a Read Only Memory (ROM) or a Random Access Memory (RAM).

The first processor 200 executes the first control program 221 stored in the first memory 220 and, by this, the first control section 26 communicates with the information processing device 3 via the first communication I/F 20.

The first control section 26 detects the position of the indicator 6 on the projection surface 4 by the first processor 200 executing the first control program 221 stored in the first memory 220. The first control section 26 acquires a captured image from the infrared camera 25, and detects the coordinates of the position of the reflected light in the captured image thus acquired as the position of the indicator 6.

The first control section 26 causes the image processing section 21 and the Projector 23 to emit image light to the projection surface 4 to thereby display an image on the projection surface 4 by the first processor 200 executing the first control program 221 stored in the first memory 220. Specifically, the first control section 26 causes the first image processing section 211 to execute development of image data of an image supplied from the information processing device 3 in the frame memory 22 and processing of the image data developed in the frame memory 22. The first control section 26 causes the second image processing section 212 execute the drawing processing based on the position of the indicator 6 thus detected. The first control section 26 turns on the light source 231, drives the optical modulation device 232, and causes the Projector 23 to emit image light to display an image on the projection surface 4. The first control section 26 controls the optical unit 233 to adjust the zoom and focus of the optical unit 233.

When the Projection system 2 and the information processing device 3 are communicably connected to each other, the first control section 26 in the present embodiment displays a first icon IC1 on the projection surface 4. The first control section 26 develops the image data of the first icon IC1 in the frame memory 22 to thereby display the first icon IC1 on the projection surface 4.

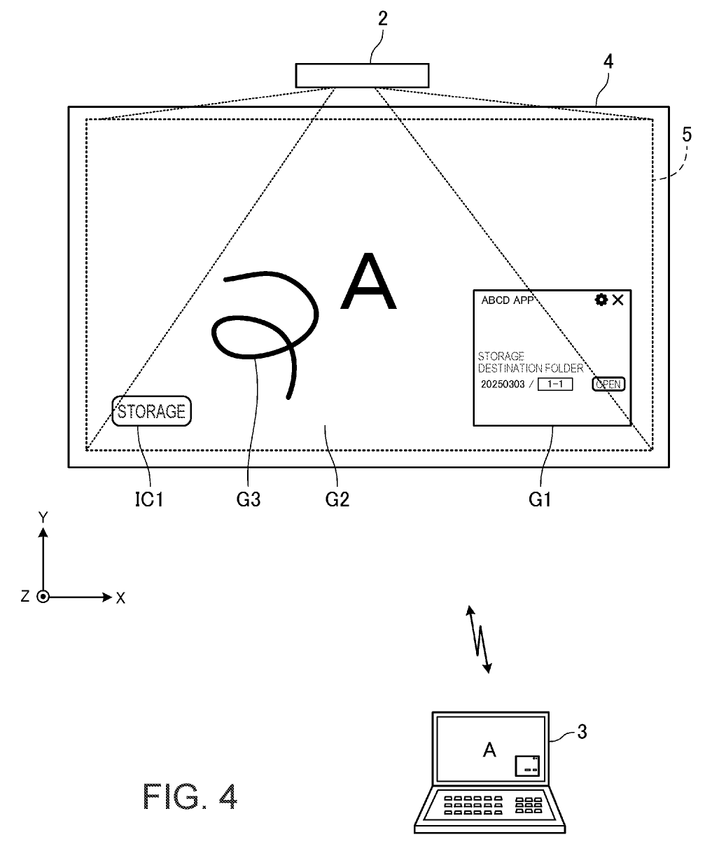

FIG. 4 is a figure illustrating an example of the first icon IC1.

FIG. 4 illustrates a case where the information processing device 3 and the Projection system 2 screen share. That is, FIG. 4 illustrates the case in which the Projection system 2 displays the image displayed by the information processing device 3 on the projection surface 4.

In the example of FIG. 4, the image displayed by the information processing device 3 includes a second image G2 and a first image G1 superimposed on the second image G2. The first image G1 is an image displayed by an application program 312 stored in the information processing device 3. It should be noted that the application program 312 and the first image G1 will be described in detail later. Hereinafter, the application program 312 is referred to as an APP 312. The second image G2 is an image different from the first image G1, and is an image displayed by a program other than APP 312. In FIG. 4, the second image G2 is an image illustrating the letter "A".

In the example illustrated in FIG. 4, the image displayed on the projection surface 4 includes a third image G3. In FIG. 4, the third image G3 is displayed superimposed on the second image G2.

The first icon IC1 is an icon for storing the image displayed by the projection surface 4. That is, the first icon IC1 is an icon for capturing an image displayed by the projection surface 4. It should be noted that the display position of the first icon IC1 is not limited to the position illustrated in FIG. 4, and may be, for example, the lower right section, but, considering that it will be operated by a person, is preferably at a position lower than the central section of the projection surface 4 in the vertical direction.

The first processor 200 executes the first control program 221 stored in the first memory 220, and thereby the first control section 26 receives an operation of selecting the first icon IC1. To be specific, when the first icon IC1 is displayed, and the detected position of the indicator 6 corresponds to the display position of the first icon IC1, the first control section 26 accepts an operation of selecting the first icon IC1.

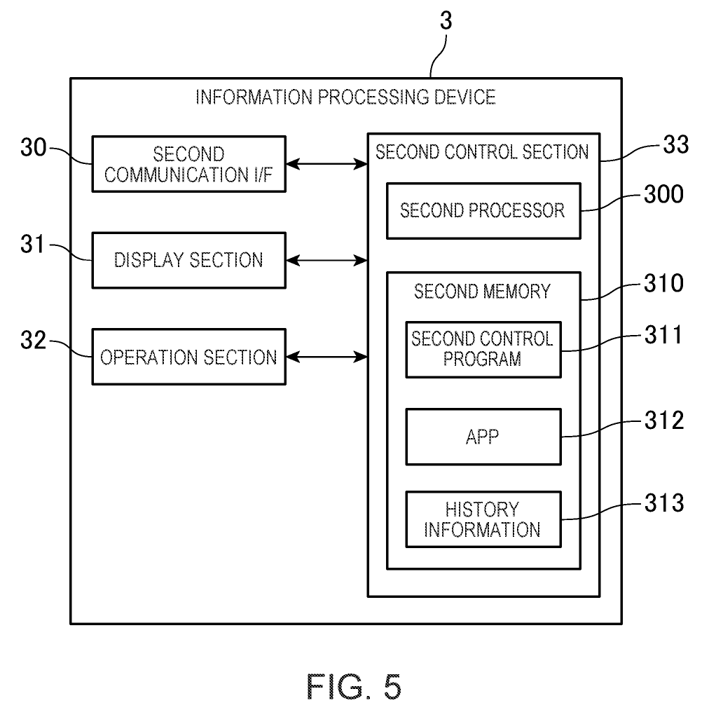

Next, a configuration of the information processing device 3 will be described with reference to FIG. 5.

FIG. 5 is a block diagram illustrating a configuration of the information processing device 3.

The information processing device 3 includes a second communication I/F 30, a display section 31, an operation section 32, and an operation second control section 33.

The second communication I/F 30 includes a connector, an interface circuit, and the like that conform to a predetermined communication standard. The second communication I/F 30 communicates with the Projection system 2 under the control of the second control section 33.

The display section 31 includes a display such as a liquid crystal display or an organic Electro Luminescence (EL) display.

The operation section 32 includes an input device such as a mouse or a keyboard, and receives an operation of a user. The operation section 32 outputs an operation signal corresponding to the received operation to the second control section 33.

The second control section 33 is a computer device including a second processor 300 such as a CPU or an MPU, and a second memory 310.

The second memory 310 is a storage device that stores programs and data. The second memory 310 stores a second control program 311, an APP 312, history information 313, data processed by the second processor 300, and the like. The second memory 310 has a non-volatile storage region. The second memory 310 includes a volatile storage region and constitutes a work area of the second processor 300. The second memory 310 is configured by, for example, a ROM or a RAM.

The second processor 300 executes the second control program 311 stored in the second memory 310, and thus the second control section 33 displays the second image G2 on the display included in the display section 31.

The second processor 300 executes the APP 312 stored in the second memory 310, whereby the second control section 33 communicates with the Projection system 2 via the second communication I/F 30.

The second processor 300 executes the APP 312 stored in the second memory 310, and thus the second control section 33 causes the display included in the display section 31 to display the first image G1. The second control section 33 displays the first image G1 so as to be superimposed on the second image G2.

The second processor 300 executes the APP 312 stored in the second memory 310, whereby the second control section 33 receives an operation on the first image G1 via the operation section 32.

Here, the first image G1 will be described.

The first image G1 is an image related to the storage of the image displayed on the projection surface 4. The first image G1 includes a folder name setting image G11. The folder name setting image G11 is a first image G1 related to setting of a folder name for storing the capture image data.

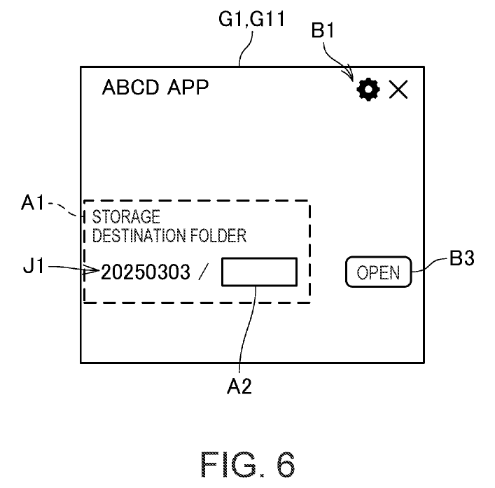

FIG. 6 is a figure illustrating an example of the folder name setting image G11.

As illustrated in FIG. 6, the folder name setting image G11 has a folder name setting region A1. The folder name setting region A1 includes date information J1 and folder information display region A2.

The date information J1 is an example of "second folder information".

The date information J1 is information indicating the date when the first image G1 is displayed.

The folder information display region A2 is a region for displaying the first folder information J2.

Hereinafter, the folder information display region A2 will be described in detail, but before the folder information display region A2 is described in detail, the first folder information J2 and the history information 313 will be described.

The first folder information J2 is information constituting a folder name for storing the capture image data.

The history information 313 is information indicating a history of the first folder information J2 used as a folder name for storing the capture image data. The history information 313 includes the first folder information J2 displayed in the folder information display region A2 and also is used as the folder name for storing the capture image data. It should be noted that the history information 313 is stored in a local folder of the information processing device 3.

When the first folder information J2 is included in the history information 313 and an operation of selecting the folder information display region A2 is received, the second control section 33 displays a list image G4 in the folder name setting image G11. It should be noted that the operation of selecting the folder information display region A2 is, for example, an operation of clicking the mouse in a state where the cursor is superimposed on the folder information display region A2.

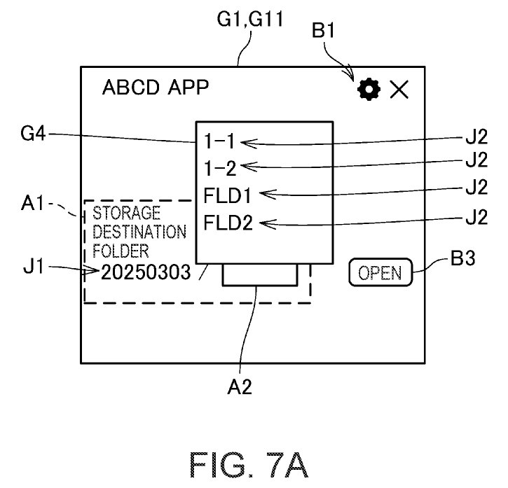

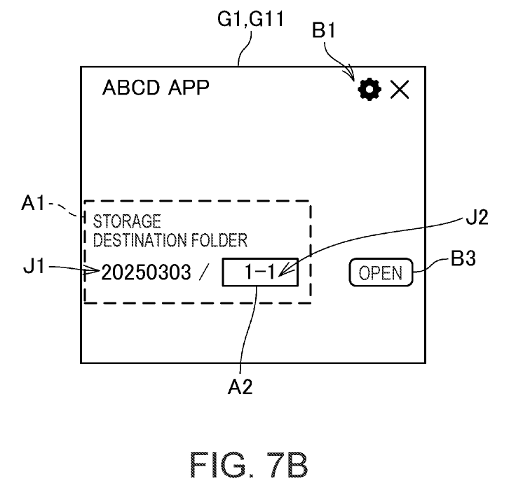

FIG. 7A and FIG. 7B are for explaining the list image G4.

FIG. 7A illustrates a folder name setting image G11 for displaying the list image G4.

The list image G4 is a screen for displaying a list of the first folder information J2 included in the history information 313. In the example of FIG. 7A, each character string "1-1", "1-2", "FLD1", and "FLD2" is first folder information J2. The list image G4 displays each set of the first folder information J2 in a selectable manner.

When a selection operation of first folder information J2 in the list image G4 is received, the second control section 33 hides the list image G4 and displays the first folder information J2 selected in the list image G4 in the folder information display region A2. By this, the first folder information J2 selected from the list image G4 is input to the folder information display region A2. In FIG. 7A, the first folder information J2 of "1-1" is selected in the first list image G4, and in FIG. 7B, the selected first folder information J2 of "1-1" is input in the folder information display region A2.

It should be noted that the first folder information J2 displayed in the list in the list image G4 can be added by an editing image G12. That is, new first folder information J2 can be added to the history information 313.

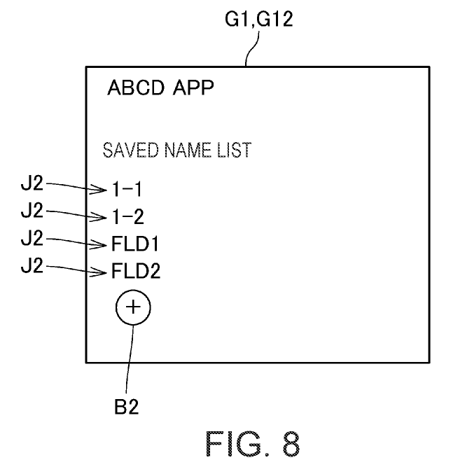

FIG. 8 is a figure illustrating an example of the editing image G12.

The editing image G12 is an image related to editing of the first folder information J2 included in the history information 313.

The second control section 33 displays the editing image G12 on the display section 31 by receiving an operation on a first button B1 displayed by the folder name setting image G11. It should be noted that the first button B1 is a software button.

The editing image G12 displays a list of the first folder information J2 included in the history information 313. In the editing image G12, each item of the first folder information J2 is displayed so as to be selectable. When one item of the first folder information J2 is selected in the editing image G12 and an operation of deleting the selected item of the first folder information J2 is performed, the selected item of the first folder information J2 is deleted from the history information 313. When one of the first folder information J2 is selected in the editing image G12 and an operation of changing the selected first folder information J2 is performed, the selected first folder information J2 is updated to the first folder information J2 after the change in the history information 313.

The editing image G12 displays the second button B2. The second button B2 is a software button for adding first folder information J2. When first folder information J2 is added using the second button B2 in the editing image G12, the history information 313 includes new first folder information J2.

Referring back to FIG. 6, the folder name setting image G11 displays a third button B3. The third button B3 is a software button for opening a folder having a folder name constituted by the date information J1 and the first folder information J2 displayed in the folder information display region A2. The third button B3 is grayed out and is not operable when no folder has been generated with a folder name constituted by the date information J1 and the first folder information J2 displayed in the first folder information display region A2.

Returning to the description of the second control section 33, the second control section 33 stores the capture image data by the second processor 300 executing the APP 312 stored in the second memory 310.

Specifically, when the first icon IC1 is operated in a case where the folder information display region A2 displays the first folder information J2, the second control section 33 stores the capture image data.

When a folder having the folder name indicated by the folder name setting region A1 has not been generated in a storage folder FD, which is for storing the storage destination folder where the capture image data is to be stored, the second control section 33 generates a folder having the folder name indicated by the folder name setting region A1 in the storage folder FD. Then, the second control section 33 stores the capture image data in the generated folder as a storage destination folder.

On the other hand, when a folder having the folder name indicated by the folder name setting region A1 is generated in the storage folder FD, the second control section 33 stores the capture image data in the generated folder as the storage destination folder.

It should be noted that the storage folder FD and the folders generated in the storage folder FD are local folders of the information processing device 3. The link of the storage folder FD is stored in the second memory 310. The second control section 33 reads the link of the storage folder FD from the second memory 310, and generates a folder or stores capture image data based on the read link.

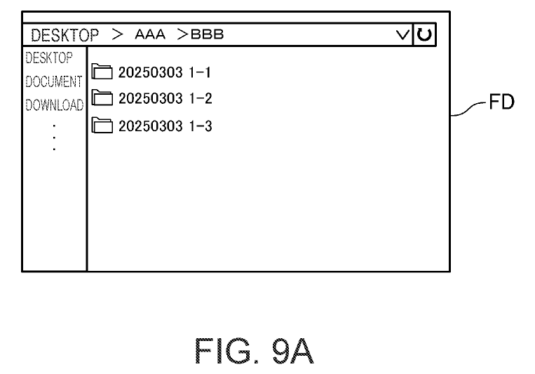

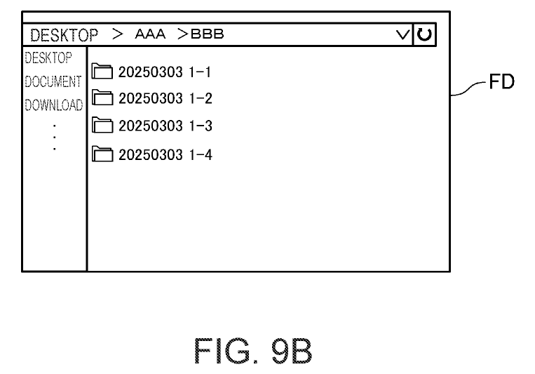

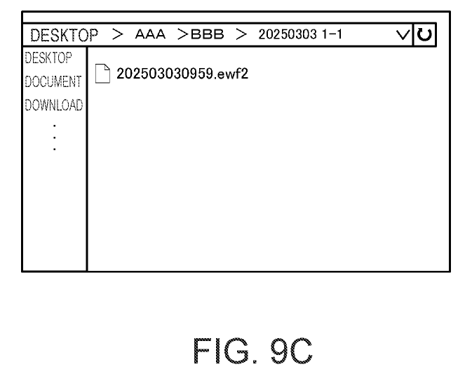

FIG. 9A, FIG. 9B, and FIG. 9C are figures for explaining storage of the capture image data.

In FIG. 9A, FIG. 9B, and FIG. 9C, when the date information J1 in the folder name setting region A1 is "20250303” and the first folder information J2 in the folder information display region A2 is "1-4", the capture image data is saved by operating the first icon IC1.

In the example of FIG. 9A, a folder having a folder name of "202503031-4" configured by "20250303" and "1-4" has not been generated in the storage folder FD. Therefore, as illustrated in FIG. 9B, the second control section 33 generates a folder having a folder name of "202503031-4" in the storage folder FD. Next, as illustrated in FIG. 9C, the capture image data is stored in the generated folder "202503031-4". In the example illustrated in FIG. 9C, the data with the file name "202503030959" is capture image data. It should be noted that although in FIG. 9C, EWF2 format is illustrated as the data format of the capture image data to be stored, the data format of the capture imaged data to be stored may be another format, such as JPEG format or PPTX format.

It should be noted that if a folder having the folder name "202503031-4" has been generated in the storage folder FD, the second control section 33 does not generate a new folder in the storage folder FD. In this case, the second control section 33 stores the capture image data in the generated folder "202503031-4".

When the second control section 33 stores the capture image data, it displays a second icon IC2 in the folder name setting image G11.

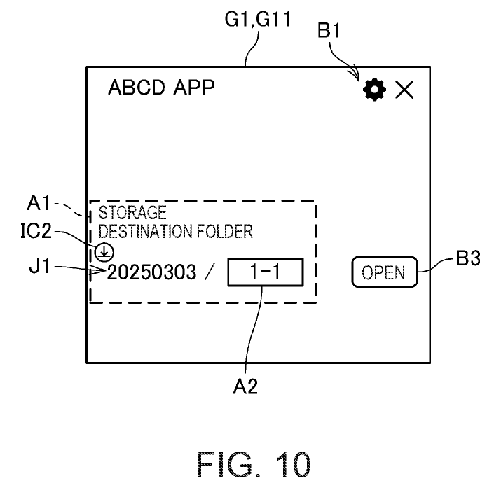

FIG. 10 is a figure illustrating an example of a folder name setting image G11 in which the second icon IC2 is displayed.

The second icon IC2 is an icon indicating that the capture image data is stored. Although FIG. 10 illustrates a case where the second icon IC2 is displayed in the upper left portion of the date information J1, the display position of the second icon IC2 is not limited to the position illustrated in FIG. 10. It should be noted that the picture pattern of the second icon IC2 is not limited to the picture pattern illustrated in FIG. 10. For example, the picture pattern of the second icon IC2 may indicate the number of times the first icon IC1 is operated after the first folder information J2 is displayed in the folder information display region A2. That is, the picture pattern of the second icon IC2 may indicate the number of times that capture image data was stored since the first folder information J2 was displayed in the folder information display region A2.

### 1-3. Operation of each section of System

Next, the operation of each section of the System 1 in the present embodiment will be described.

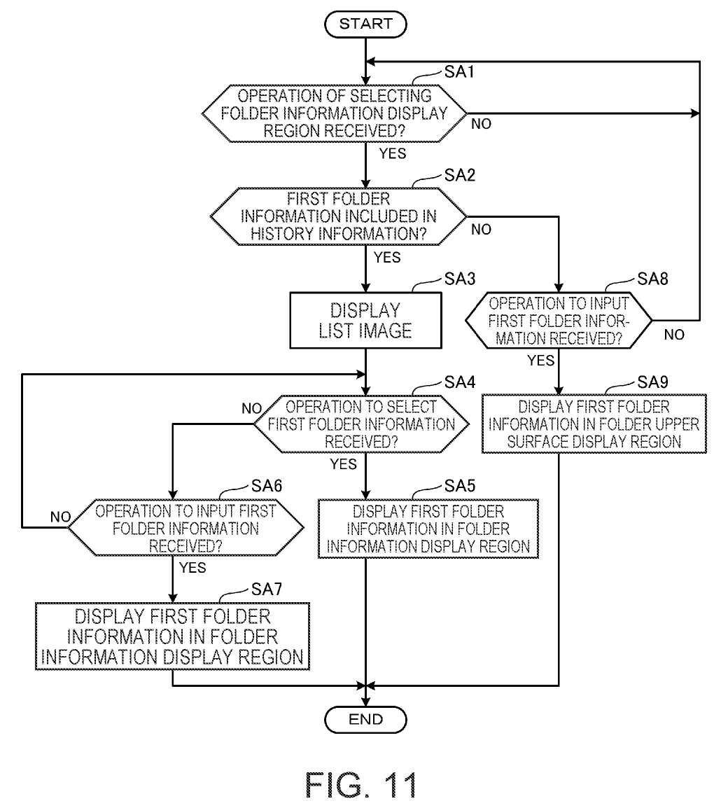

First, the operation of the information processing device 3 related to the setting of the first folder information J2 will be described with reference to FIG. 11.

FIG. 11 is a flowchart illustrating the operation of the information processing device 3.

The second control section 33 determines whether or not an operation of selecting the folder information display region A2 was received (step SA1).

When the second control section 33 determines that the operation of selecting the folder information display region A2 was not received (step SA1: NO), the second control section 33 performs the determination of step SA1 again.

On the other hand, when it is determined that an operation of selecting the folder information display region A2 was received (step SA1: YES), the second control section 33 determines whether or not the first folder information J2 is included in the history information 313 (step SA2).

When the second control section 33 determines that the first folder information J2 is included in the history information 313 (step SA2: YES), the second control section 33 displays the list image G4 on the folder name setting image G11 (step SA3).

Next, the second control section 33 determines whether or not an operation of selecting the first folder information J2 was received (step SA4).

When the second control section 33 determines that an operation of selecting the first folder information J2 was received (step SA4: YES), the second control section 33 displays the selected first folder information J2 in the folder information display region A2 (step SA5).

On the other hand, when the second control section 33 determines that an operation of selecting the first folder information J2 was not received (step SA4: NO), the second control section 33 determines whether or not an operation of inputting the first folder information J2 was received by a keyboard or the like (step SA6).

When the second control section 33 receives the operation of inputting the first folder information J2 (step SA6: YES), the second control section 33 displays the first folder information J2 input by the operation in the folder information display region A2 (step SA7).

On the other hand, when an operation of inputting the first folder information J2 was not received (step SA6: NO), the second control section 33 returns the process to step SA4 and performs the process of step SA4 again.

Returning to the description of step SA2, when the second control section 33 determines that the first folder information J2 is not included in the history information 313 (step SA2: NO), the second control section 33 determines whether or not an operation of inputting the first folder information J2 was received by a keyboard or the like (step SA8).

When the second control section 33 receives an operation of inputting the first folder information J2 (step SA8: YES), the second control section 33 displays, in the folder information display region A2, the first folder information J2 that was input by the operation (step SA9).

On the other hand, when an operation of inputting the first folder information J2 was not received (step SA8: NO), the second control section 33 returns the process to step SA1 and performs the process of step SA1 again.

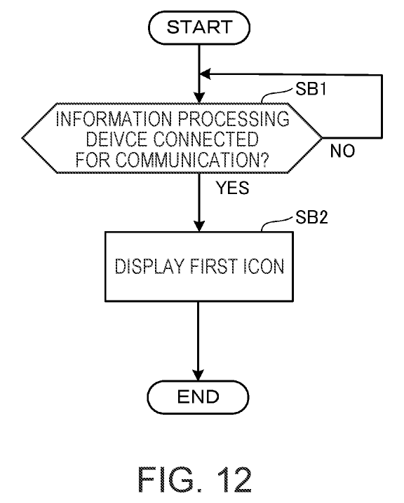

Next, the operation of the Projection system 2 related to the display of the first icon IC1 will be described. FIG. 12 is a flowchart illustrating the operation of the Projection system 2.

The first control section 26 determines whether or not a communication connection has been established with the information processing device 3 (step SB1). When the first control section 26 determines that the communication connection with the information processing device 3 has not been established (step SB1: NO), the first control section 26 performs the determination of step SB1 again.

On the other hand, when the first control section 26 determines that a communication connection with the information processing device 3 has been established (YES in step SB1), the first control section 26 displays the first icon IC1 on the projection surface 4 (step SB2).

Next, operations related to storage of capture image data will be described.

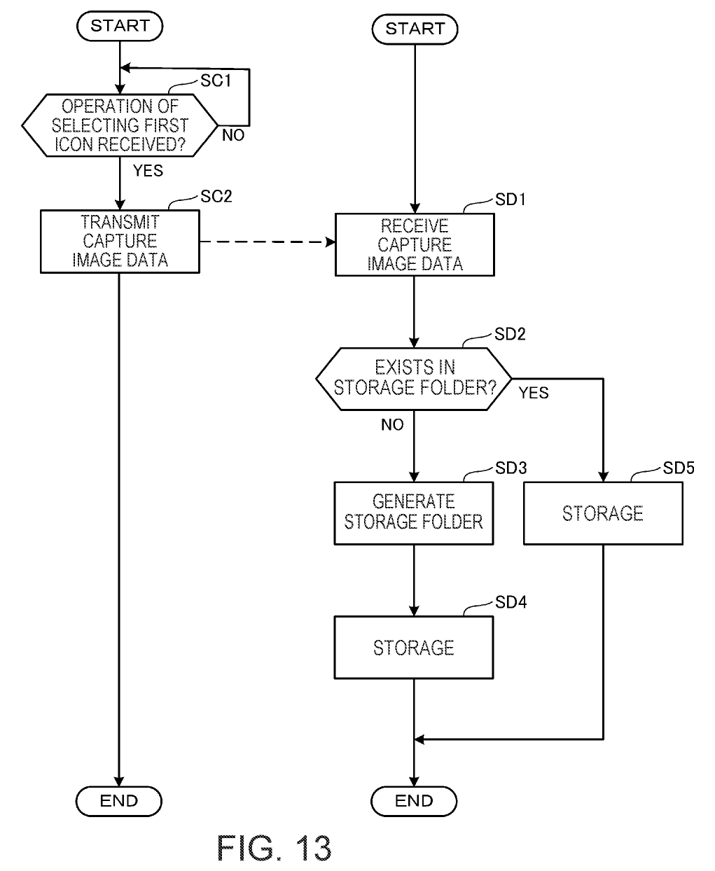

First, the operation in the case in which the Projection system 2 and the information processing device 3 do not screen share will be described with reference to FIG. 13.

FIG. 13 is a flowchart illustrating the operation of the Projection system 2 and the information processing device 3. In FIG. 13, the flowchart on the right side in the drawing illustrates the operation of the Projection system 2, and the flowchart on the left side in the figure illustrates the operation of the information processing device 3.

At the operation start time in FIG. 13, the Projection system 2 displays the first icon IC1. At the operation start time in FIG. 13, the folder information display region A2 displays the first folder information J2.

The first control section 26 determines whether or not an operation of selecting the first icon IC1 was received (step SC1).

When the first control section 26 determines that an operation of selecting the first icon IC1 has not been received (step SC1: NO), the first control section 26 performs the process of step SC1 again.

On the other hand, when the first control section 26 determines that an operation of selecting the first icon IC1 was received (step SC1: YES), the first control section 26 transmits the capture image data to the information processing device 3 (step SC2).

Step SC2 will be described in detail.

When the image displayed on the projection surface 4 is an image supplied by the information processing device 3, the first control section 26 transmits the image data of the image supplied by the information processing device 3 to the information processing device 3 as the capture image data.

When the image displayed on the projection surface 4 is a third image G3 that was drawn by an operation on the projection surface 4, the first control section 26 transmits the image data of the third image G3 to the information processing device 3 as the capture image data.

When the image displayed on the projection surface 4 is the image supplied by the information processing device 3 and the third image G3 that was drawn by an operation on the projection surface 4, the first control section 26 transmits, to the information processing device 3, to the information processing device 3 capture image data in which the third image G3 is superimposed on the image data supplied by the information processing device 3.

The second control section 33 receives the capture image data from the Projection system 2 (step SD1).

Next, the second control section 33 determines whether or not a folder having a folder name configured by the date information J1 and the first folder information J2 is present in the storage folder FD (step SD2).

When the second control section 33 determines that no folder exists in the storage folder FD (step SD2: NO), the second control section 33 generates a folder having a folder name configured by the date information J1 and the first folder information J2 in the storage folder FD (step SD3).

Next, the second control section 33 stores the capture image data received in step SD3 in the folder generated in step SD1 (step SD4).

The description returns to step SD2. When the second control section 33 determines that capture image data is present in the storage folder FD (step SD2: YES), the second control section 33 stores the capture image data received in step SD1 in the folder having a folder name including the date information J1 and the first folder information J2 (step SD5).

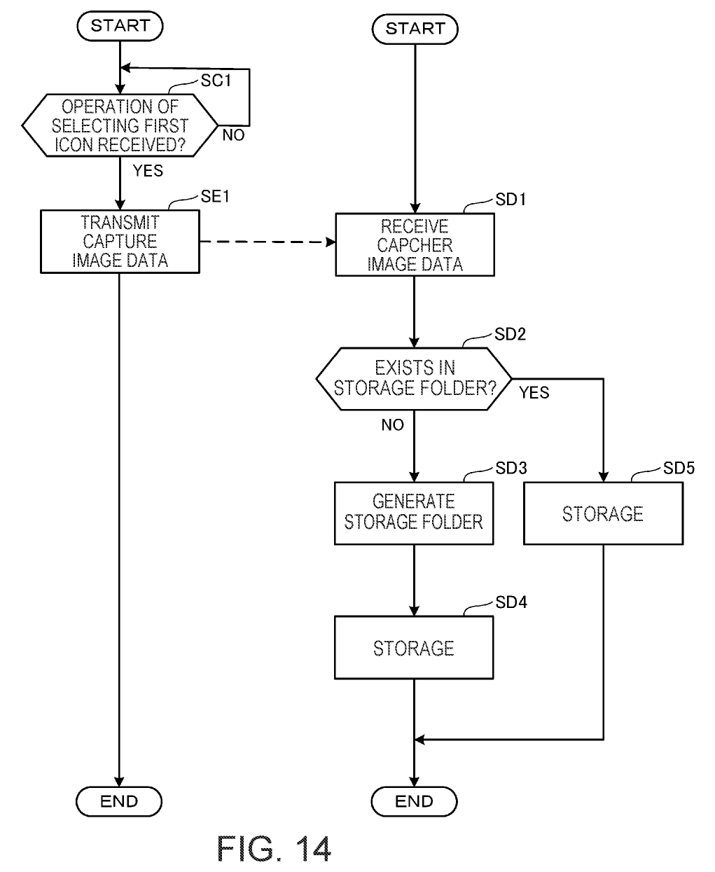

Next, an operation in a case where the Projection system 2 and the information processing device 3 screen share will be described with reference to FIG. 14.

FIG. 14 is a flowchart illustrating the operation of the Projection system 2 and the information processing device 3. In FIG. 14, the flowchart on the right side in the drawing illustrates the operation of the Projection system 2, and the flowchart on the left side in the figure illustrates the operation of the information processing device 3.

In FIG. 14, the same steps as those in FIG. 13 are denoted by the same reference numerals. In the description of FIG. 14, the detailed description of the same steps as those in FIG. 13 will be omitted as appropriate.

At the operation start time in FIG. 14, the Projection system 2 displays the first icon IC1. At the operation start time in FIG. 14, the folder information display region A2 displays the first folder information J2. At the operation start time in FIG. 14, the Projection system 2 is displaying the image supplied from the information processing device 3 on the projection surface 4.

When the first control section 26 determines that an operation of selecting the first icon IC1 was received (YES in step SC1), the first control section 26 transmits the image data displayed by the projection surface 4 to the information processing device 3 (step SE1).

Step SE1 will be described in detail.

When the Projection system 2 and the information processing device 3 screen share, the information processing device 3 supplies the first image G1 and the second image G2 to the Projection system 2.

When the images displayed on the projection surface 4 are the first image G1 and the second image G2, the first control section 26 transmits the image data of the second image G2 to the information processing device 3 as capture image data.

When the images displayed on the projection surface 4 are the first image G1, the second image G2, and the third image G3, the first control section 26 transmits the image data of an image in which the third image G3 is superimposed on the second image G2 to the information processing device 3 as capture image data.

Next, the effects of the present embodiment will be described by exemplifying a case where the System 1 is used in a classroom scenario. In this classroom scenario, a case is illustrated in which the teacher give a lesson by connecting the information processing device 3 carried by the teacher to the Projection system 2 and by displaying materials used in the lesson on the projection surface 4. The teacher may select the first folder information J2 in the first image G1 displayed by the information processing device 3 when setting the folder name of the storage destination of the capture image data. Therefore, it is not necessary to operate the keyboard in the setting of the folder name, and the image displayed by the projection surface 4 can be easily stored. Even if the keyboard is operated when the folder name of the storage destination is set, the folder name can be set by the keyboard of the information processing device 3, and thus the teacher can set the folder name by the keyboard he/she is used to using. The teacher can save the capture image data by simply selecting the first icon IC1 displayed by the Projection system 2. The teacher can therefore save the capture image data without going back and forth between the projection surface 4 and the information processing device 3, as compared with the configuration in which the capture image data is saved by operating the information processing device 3.

### 2. Second Embodiment

Next, a second embodiment will be described.

The second embodiment is different from the first embodiment in the operation related to the storage of the capture image data when the Projection system 2 and the information processing device 3 screen share.

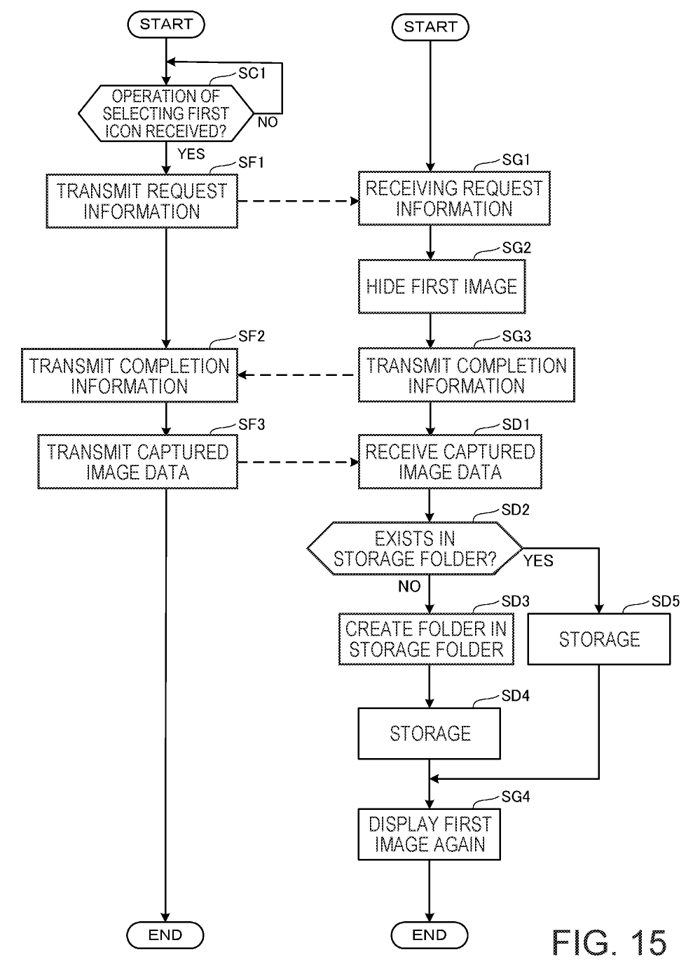

FIG. 15 is a flowchart illustrating the operation of the Projection system 2 and the information processing device 3. In FIG. 15, the flowchart on the right side in the drawing illustrates the operation of the Projection system 2, and the flowchart on the left side in the figure illustrates the operation of the information processing device 3.

In FIG. 15, the same steps as those in FIG. 14 are denoted by the same reference numerals. In the description of FIG. 15, the detailed description of the same steps as those in FIG. 14 will be omitted as appropriate.

When the first control section 26 determines that an operation of selecting the first icon IC1 has been received (step SC1: YES), the first control section 26 transmits request information for requesting non-display of the first image G1 to the information processing device 3 (step SF1).

When the second control section 33 receives the request information from the Projection system 2 (step SG1), the second control section 33 hides the first image G1 (step SG2).

Subsequently, the second control section 33 transmits completion information indicating that the first image G1 is hidden to the Projection system 2 (step SG3).

When the first control section 26 receives the completion information from the information processing device 3 (step SF2), the first control section 26 transmits the capture image data to the information processing device 3 (step SF3).

Step SG3 will be described in detail.

When the process of step SG3 is performed, the first image G1 is not displayed, and therefore, the information processing device 3 supplies the second image G2 to the Projection system 2.

When the image displayed on the projection surface 4 is the second image G2, the first control section 26 transmits the image data of the second image G2 to the information processing device 3 as the capture image data.

When the images displayed on the projection surface 4 are the second image G2 and the third image G3, the first control section 26 transmits image data of an image in which the third image G3 is superimposed on the second image G2 to the information processing device 3 as the capture image data.

When the image data is saved, the second control section 33 displays the first image G1 again (step SG4). The first image G1 is thus displayed again on the projection surface 4.

### 3. Other Embodiments

The above-described embodiments are suitable embodiments of the present disclosure. However, the present disclosure is not limited to the above-described embodiments, and various modifications can be made without departing from the gist of the present disclosure.

In the above-described embodiment, the case where the "second folder information" is the date information J1 has been exemplified. In another embodiment, the "second folder information" may be date and time information indicating a time other than the date.

In the above-described embodiment, the date information J1 is exemplified as the "second folder information", and the case where the "second folder information" is information that is automatically determined is exemplified. In another embodiment, the "second folder information" may be selected and input in the folder name setting image G11, similarly to the first folder information J2. In this configuration, the information processing device 3 displays a list image of the second folder information and receives an operation of selecting the second folder information via the list image, as in the case of the first folder information J2. In this configuration, the information processing device 3 stores the "second folder information" used as the folder name of the storage destination of the capture image data in the local folder as history, and displays the list image based on the stored history. The "second folder information" stored in the local folder may be editable similarly to the first folder information J2.

In the embodiment described above, the Projection system 2 is illustrated as the "displayer", but the "displayer" is not limited to the projection system 2, and can also be a displayer provided with a touch panel and capable of operating the display surface of the touch panel.

The history information 313 may be configured as text data stored in the storage folder FD, and the first folder information J2 included in the history information 313 may be described as text in the text data. In this configuration, the information processing device 3 receives the editing of the first folder information J2 included in the history information 313 by receiving the editing of the text described in the text data. In this configuration, the information processing device 3 may be configured not to display the editing image G12.

The functions of the first control section 26 and the second control section 33 may be realized by a plurality of processors or semiconductor chips.

The respective section of the Projection system 2 illustrated in FIG. 3 and the sections of the information processing

device 3 illustrated in FIG. 5 illustrate the functional configurations, and the specific implementation forms are not particularly limited. That is, hardware individually corresponding to each functional section does not necessarily need to be mounted, and a configuration may be adopted in which a plurality of functions are realized by one processor executing a program. In the above embodiment, a part of the functions realized by software may be realized by hardware, and a part of the functions realized by hardware may be realized by software. In addition, the specific detailed configuration of each of the other sections of the Projection system 2 and the information processing device 3 can also be arbitrarily changed without departing from the range of the present disclosure.

Hereinafter, a summary of the present disclosure is appended.

Further, the processing units in the flowcharts illustrated in FIGS. 11, 12, 13, 14, and 15, are obtained by dividing the processing in accordance with the main processing contents in order to facilitate understanding of processes by the Projection system 2 and the information processing device 3, and the present disclosure is not limited by the way of dividing the processing units or the names of the processing units. The processing contents may be divided into image data storage methods and many units of steps. The processing may be divided so that one step unit includes many processes. The order of steps may be changed as appropriate within a range not interfering with the gist of the present disclosure.

### SUMMARY OF PRESENT DISCLOSURE

### Appendix 1

An image data storage method includes receiving, at an information processing device that is communicably connected to a displayer that displays an image on a display surface, an operation of selecting first folder information; displaying, by the displayer, a first icon for storing an image displayed on the display surface; receiving, at an information processing device that is communicably connected to a displayer that displays an image on a display surface, an operation of selecting first folder information; storing, by the information processing device, image data of the image displayed on the display surface in a folder having a folder name based on second folder information and the first folder information.

By this, since the folder name can be set without operating the keyboard, the image data of the image displayed on the display surface can be easily stored. The user can store the image data only by selecting the first icon displayed by the displayer. Therefore, the user can store the image data without moving between the display surface and the information processing device, as compared with a configuration in which the image data is stored by operating the information processing device.

### Appendix 2

The image data storage method according to Appendix 1, wherein the folder having the folder name is a local folder of the information processing device.

This makes it possible to store the image data in a folder that cannot be accessed by the displayer. Therefore, the image data can be stored in the local folder without the trouble of downloading the image data from the shared folder.

### Appendix 3

The image data storage method according to Appendix 1 or Appendix 2, wherein the first folder information is stored in a local folder of the information processing device.

This enables the user to select the first folder information from among the first folder information stored in the information processing device to be operated. Therefore, compared to a case where the first folder information is stored in a shared folder shared by a plurality of information processing device, the number of options of the first folder information can be reduced, and the operation of setting the folder name can be suppressed from becoming complicated.

### Appendix 4

The image data storage method according to any one of Appendix 1 to 3, wherein the second folder information includes date information indicating a date.

By this, by adopting a configuration in which the second folder information includes the date information, even when the same first folder information is set on different days, it is possible to suppress the folder name of the folder that stores the image data from being duplicated.

### Appendix 5

The image data storage method according to any one of Appendix 1 to Appendix 4, wherein the displayer displays, in a superimposed manner by an application program stored in the information processing device, a first image displayed by the information processing device, a second image other than the first image displayed by the information processing device, and a third image drawn by an operation on the display surface, the second image is an image that receives an operation of selecting the first folder information, and storing includes storing the image data in which the first image and the third image are superimposed.

By this, since the image data that does not include the image for receiving the operation of selecting the first folder information can be stored, the visibility of the image indicated by the stored image data can be improved.

### Appendix 6

The image data storage method according to any one of Appendix 1 to Appendix 5, wherein the information processing device receives an operation of selecting the second folder information.

By this, since the folder name can be set without operating the keyboard, the image data of the image displayed on the display surface can be easily stored.

### Appendix 7

The image data storage method according to any one of Appendix 1 to Appendix 6, wherein when the image data has been saved, the displayer displays a second icon indicating that the image data has been saved.

This allows the user to easily grasp that the image data is saved in the folder without opening the folder.

### Appendix 8

The image data storage method according to any one of Appendix 1 to Appendix 7, wherein displaying a first image displayed by the information processing device by the application program stored in the information processing device and causing the information processing device to hide the first image after the displayer receives the operation of selecting the first icon and storing includes storing, by the information processing device, the image data after hiding the first image.

By this, since the image data that does not include the image for receiving the operation of selecting the first folder information can be stored, the visibility of the image indicated by the stored image data can be improved.

What is claimed is:

1. An image data storage method comprising:
receiving, at an information processing device that is communicably connected to a displayer that displays an image on a display surface, an operation of selecting first folder information;
displaying, by the displayer, a first icon for storing an image displayed on the display surface;
receiving, at the displayer, an operation of selecting the first icon being displayed; and
storing, by the information processing device, image data of the image displayed on the display surface in a folder having a folder name based on second folder information and the first folder information.

2. The image data storage method according to claim 1, wherein
the folder having the folder name is a local folder of the information processing device.

3. The image data storage method according to claim 1, wherein
the first folder information is stored in a local folder of the information processing device.

4. The image data storage method according to claim 1, wherein
the second folder information includes date information indicating a date.

5. The image data storage method according to claim 1, wherein
the displayer displays, in a superimposed manner by an application program stored in the information processing device, a first image displayed by the information processing device, a second image other than the first image displayed by the information processing device, and a third image drawn by an operation on the display surface,
the second image is an image that receives an operation of selecting the first folder information, and
storing includes storing the image data in which the first image and the third image are superimposed.

6. The image data storage method according to claim 1, wherein
the information processing device receives an operation of selecting the second folder information.

7. The image data storage method according to claim 1, wherein
when the image data has been saved, the displayer displays a second icon indicating that the image data has been saved.

8. The image data storage method according to claim 1, wherein
the displayer performs
displaying a first image displayed by the information processing device by the application program stored in the information processing device and
causing the information processing device to hide the first image after the displayer receives the operation of selecting the first icon and
storing includes
storing, by the information processing device, the image data after hiding the first image.
